(19) United States
(12) Patent Application Publication
(10) Pub. No.: US 2009/0208339 A1
(43) Pub. Date: Aug. 20, 2009

(54) BLADE ROOT STRESS RELIEF

(75) Inventors: Anthony P. Cherolis, East Hartford, CT (US); Richard H. Page, Guilford, CT (US); Karl A. Mentz, East Hartford, CT (US)

Correspondence Address: BACHMAN & LAPOINTE, P.C. (P&W), 900 CHAPEL STREET, SUITE 1201, NEW HAVEN, CT, 06510-2802, US

(73) Assignee: United Technologies Corporation, Hartford, CT (US)

(21) Appl. No.: 12/032,231

(22) Filed: Feb. 15, 2008

(51) Int. Cl. F01D 5/30; B21K 25/00; B23P 6/00

(52) U.S. Cl. 416/219 R; 416/193 A; 29/889.21; 29/889.2

(57) ABSTRACT

In a gas turbine engine, a stress relief is formed along a blade root and disk slot junction. An exemplary relief is a chamfer along the pressure side of the blade root extending forward from the aft face of the root.

### BACKGROUND

The disclosure relates to gas turbine engines, and more specifically to blade-to-disk attachment.

Gas turbine engines operate by burning a combustible fuel-air mixture in a combustor and converting the energy of combustion into a propulsive force. Combustion gases are directed axially rearward from the combustor through an annular duct, interacting with a plurality of turbine blade stages within the duct. The blades transfer the combustion gas energy to one or more disks, rotationally disposed about a central, longitudinal axis of the engine. In a typical turbine section, there are multiple, alternating stages of stationary vanes and rotating blades in the duct.

In gas turbine engines, the blades of fan, compressor, and turbine sections may be secured to separate disks. One attachment means involves providing blade roots having a convoluted section complementary to a convoluted section of slots in the disk periphery. An exemplary configuration involving a convoluted profile that generally increases in transverse dimension from the slot base toward its opening is called a fir tree configuration.

### SUMMARY

One aspect of the disclosure involves a stress relief formed along a blade root and disk slot junction of a gas turbine engine. An exemplary relief is a chamfer along the pressure side extending forward from the aft face of the disk/root.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a simplified schematic sectional view of a gas turbine engine along a central, longitudinal axis.

FIG. 2 is a partial front view of a turbine disk and blade.

FIG. 3 is an enlarged view of the disk and blade of FIG. 2.

FIG. 4 is an enlarged view of a root of the blade of FIG. 3 in a slot of the disk.

FIG. 5 is an exploded view of the blade and disk of FIG. 3.

FIG. 6 is a longitudinal sectional view of the disk of FIG. 3 with the blade shown in elevation.

FIG. 7 is a transverse longitudinal sectional view of the root and slot of FIGS. 4 and 6, taken along lines 7-7 of FIG. 6.

FIG. 8 is a pressure side view of the blade root.

FIG. 9 is an enlarged view of the blade and disk of FIG. 6, showing load paths.

FIG. 10 is a transverse longitudinal sectional view of a pressure side junction of the blade and slot.

FIG. 11 is an enlarged view of a chamfer/gap along the junction of FIG. 10.

FIG. 12 is a second transverse longitudinal sectional view of a pressure side junction of the blade and slot.

FIG. 13 is an enlarged view of a chamfer/gap along the junction of FIG. 12.

FIG. 14 is a transverse longitudinal sectional view of a suction side junction of the blade and slot.

FIG. 15 is an enlarged view of a chamfer/gap along the junction of FIG. 14.

FIG. 16 is a transverse longitudinal sectional view of a straight chamfer.

FIG. 17 is a transverse longitudinal sectional view of an arcuate chamfer.

FIG. 18 is a longitudinal sectional view of a radiused offset chamfer.

Like reference numbers and designations in the various drawings indicate like elements.

### DETAILED DESCRIPTION

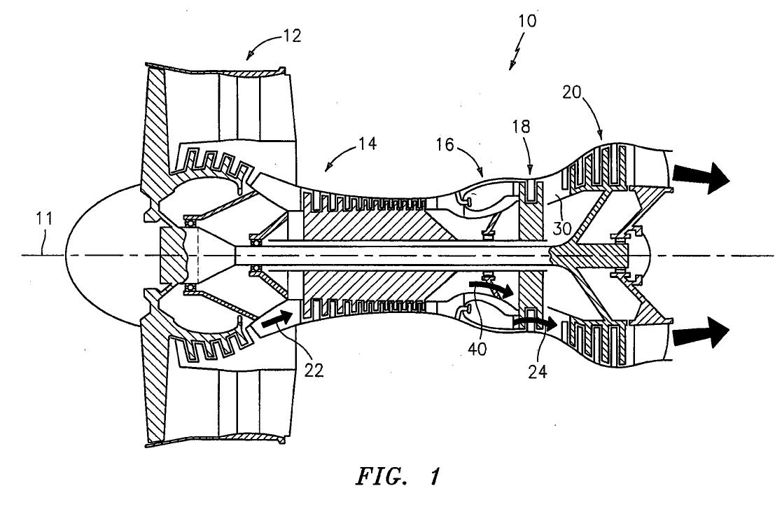

The major sections of a typical gas turbine engine 10 of FIG. 1 include in series, from front-to-rear/upstream-to-downstream and disposed about a central longitudinal axis 11: a low-pressure compressor 12; a high-pressure compressor 14; a combustor 16; a high-pressure turbine module 18; and a low-pressure turbine module 20. A working fluid 22 (e.g., initially air) is directed generally downstream/rearward along a core flowpath through the compressors 12, 14 and into the combustor 16, where fuel is injected and the mixture is burned. Hot combustion gases 24 exit the combustor 16 and expand within in an annular duct 30 through the turbines 18, 20 and exit the engine 10 as a propulsive thrust. A portion of the working fluid 22 exiting the high-pressure compressor 14, bypasses the combustor 16 and is directed to the high-pressure turbine module 18 for use as cooling air 40.

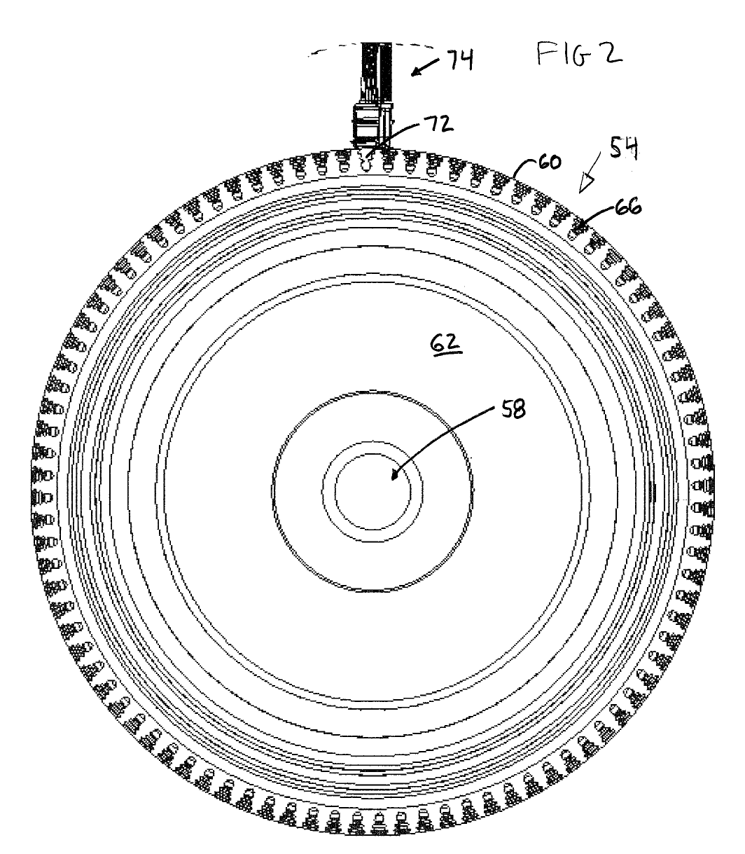

Each of the compressors and turbine modules may include a rotor assembly including a stack of disks. FIG. 2 shows an exemplary turbine disk 54 extending from an inboard bore 58 to an outboard periphery 60. A web 62 extends between the bore 58 and the periphery 60. Extending radially inward from the periphery 60 are slots 66 forming a circumferential array. The slots 66 extend longitudinally, or off-longitudinally (e.g., by a broach angle of 10-20°), between fore and aft faces on respective upstream and downstream sides of the disk. The slots 66 have convoluted, so-called fir-tree, profiles for receiving generally complementary convoluted blade roots 72. FIGS. 2 and 3 show blades 74 mounted to the disk 54. Each blade 74 has an airfoil 78 extending from an inboard end 80 at platform 82 to a tip 84 in close facing proximity to outer air seal shrouds carried by the engine case. The root 72 depends from the platform 82. Each airfoil 78 has a leading edge 85 and a trailing edge 86. Each airfoil has a suction (convex) side 88 and a pressure (concave) side 90 extending between the leading and trailing edges.

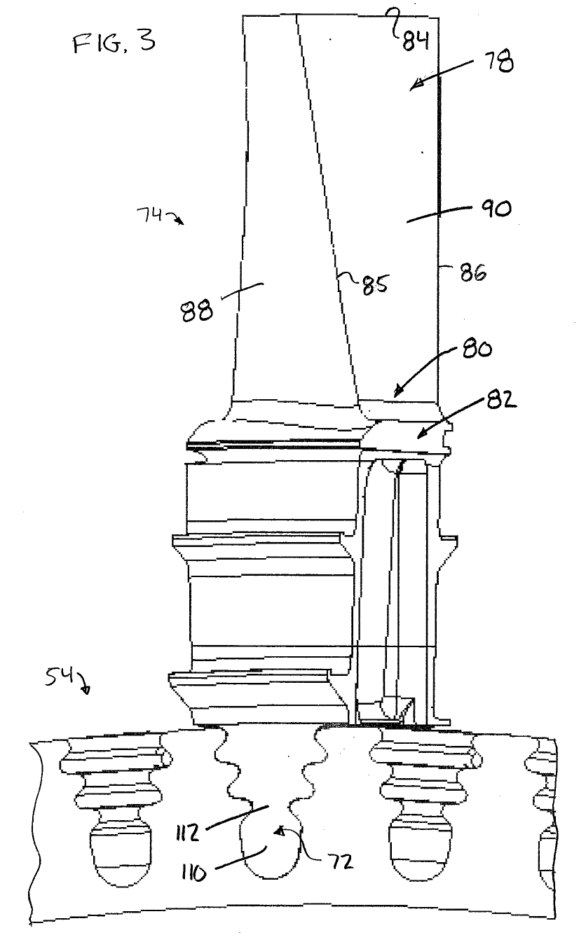

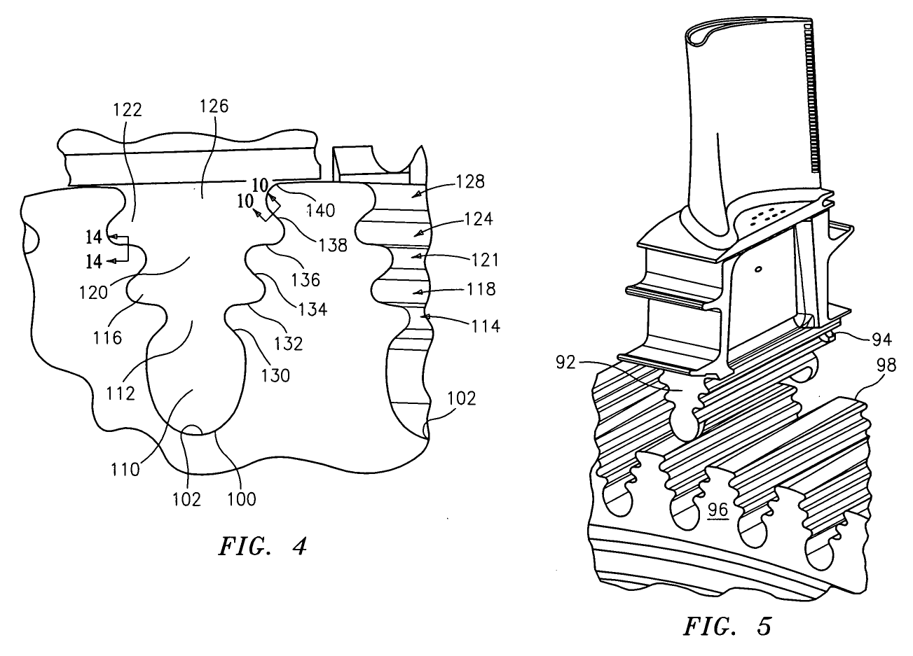

FIGS. 4 and 5 show further details of a blade attachment root 72 and the associated slot 68. The root 72 has fore and aft faces 92 and 94 which may be approximately locally aligned with fore and aft faces 96 and 98 of the disk. The exemplary root 72 extends to an inboard end 100 at an inboard end 102 of the slot. In the face-on view of FIG. 4, and associated transverse cross-section, the root 72 has a bulbous inboard head 110. A neck 112 is outboard of the head 110 at an associated narrowing 114 in the slot. A protuberance 116 is outboard of the neck 112 in an associated widening 118 of the slot. A neck 120 is outboard of the protuberance 116 in an associated narrowing 121 of the slot. A protuberance 122 is outboard of the neck 120 in a widening 124. A neck 126 is outboard of the protuberance in a narrowing 128. In the exemplary fir-tree configuration, the protuberance 116 is wider than the head 110 and, in turn, narrower than the protuberance 122. Similarly, the narrowing 120 is wider than the narrowing 114 and, in turn, narrower than the narrowing 128. Contact regions 130, 132, 134, 136, 138, and 140 on respective inboard and outboard sides of each of the narrowings may help radially retain the blade to the slot.

FIG. 7 shows local engagement between a first lateral surface 150 of the root 72 and a first lateral surface 152 of the slot and a second lateral surface 154 of the root and a second lateral surface 156 of the slot. In the exemplary implementation, the first surfaces 150 and 152 are generally circumferentially to the pressure side of the associated airfoil whereas the second surfaces 154 and 156 are generally to the suction side. The exemplary slot and root are off longitudinal (i.e., off normal to the disk faces 96 and 98) by the broach angle θ. FIG. 5 shows a local longitudinal span L₁ of the slot and adjacent root. Along the slot, a length L₂ may be slightly greater given the slot orientation. Along respective lateral sides of the root 72, the surfaces 150 and 154 define respective lobes at the head 110 and protuberances 116 and 122 with fillets or recesses therebetween. Similarly, along the lateral sides of the slots, the surfaces 152 and 156 define respective lobes along the slot narrowings and fillets along the respective slot widenings.

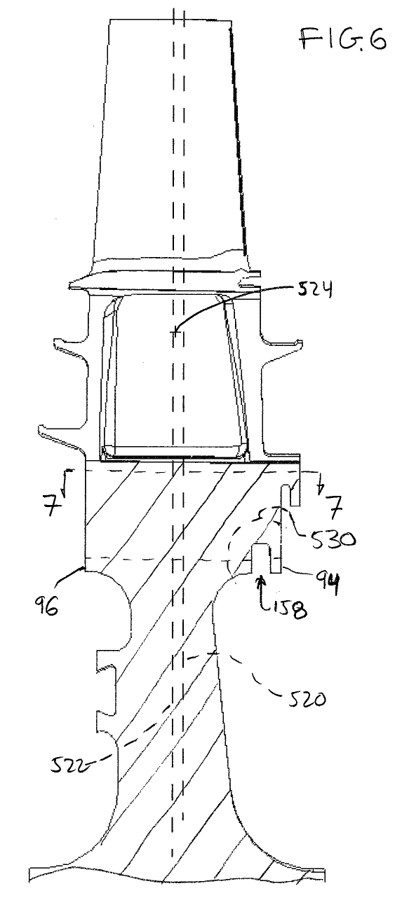

In a baseline prior art system, the root and slot surfaces may be straight and dimensioned to provide a line-on-line, or zero gap assembly fit along essentially the entire span between disk faces. We have observed undesirable effects of the associated stress patterns. Specifically, FIG. 6 shows the blade stacking line/plane 520 and the disk web mid-line/plane 522. FIG. 6 further shows the blade center of gravity 524 positioned ahead of the stacking line and slightly behind the web mid-line (e.g., by approximately 0.07 inch). Such a configuration may produce undesirable stress levels associated with both axial imbalance of the blade and axial imbalance of the combined blade and disk system. The blade and disk system imbalance may be envisioned in FIG. 6 and is associated with the blade center of gravity 524 being aft of the disk web mid-line 522. With the engine running, this spacing causes the blade to roll the disk rim/periphery 60 forward (counterclockwise as viewed in FIG. 6). This may create a high stress region 530 near the rear of the slot, with particularly high stress in the vicinity of the air supply slot 158 especially along the pressure side. The exemplary slot 158 is a radially-outwardly extending circumferential slot passing through the disk.

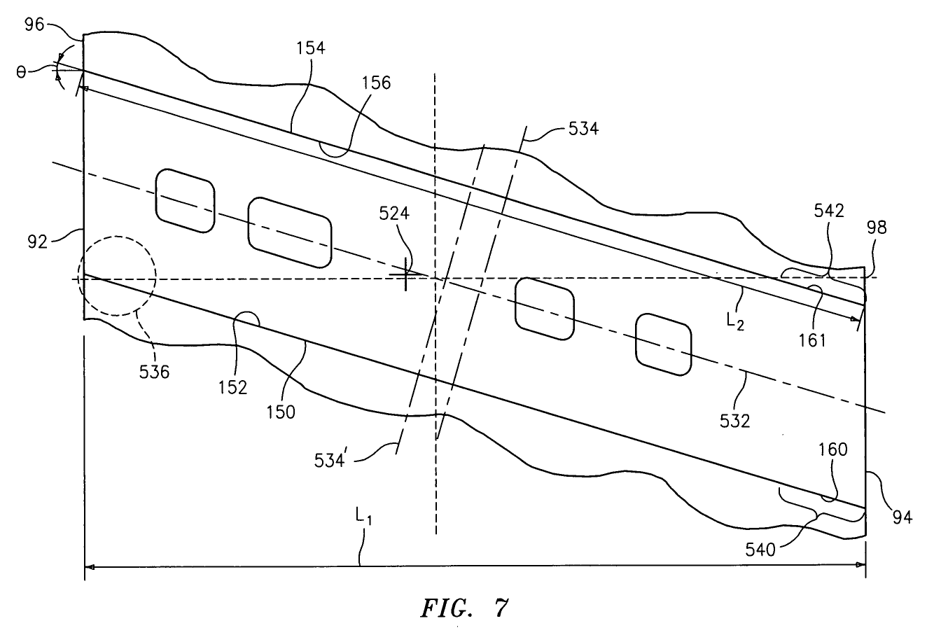

The blade component imbalance is visualized relative to FIG. 7. This imbalance is caused by the center of gravity 524 being forward of the stacking line 520 and being on the concave side of the Iₘᵢₙ axis 532. FIG. 7 further shows the Iₘₐₓ axis 534. This center of gravity location produces a high stress location 536 on the pressure side of the root and slot near the front/fore faces 92, 96 and concentrated relatively outboard. Such problems may be addressed via a longitudinally-varying stress relief. Exemplary stress relief may reduce contact engagements along an aft (trailing edge) pressure side region 540 and an aft suction side region 542 of FIG. 7. The FIG. 7 reliefs are formed by root chamfers 160 and 161 respectively along the pressure and suction sides. FIG. 8 shows an extent of the chamfer 160 (the extent of 161 being similar) as opening aftward from a forward boundary 163 at an angle θ₁. The effect of the chamfers 160 and 161 may be to forwardly shift a load path away from the slot 158 and away from a retaining ring slot 159 (extending through the disk and blades to engage a retaining ring which longitudinally secures the blades in their respective slots).

FIG. 9 shows a shifted load path from a baseline 550 to a revised load path 550′. Load which, in the baseline, is concentrated at a region 552 in the outboard front corner of the slot 158 is better transitioned into the disk web. An exemplary 8% peak stress reduction in this area may be achieved.

The reliefs may also forwardly shift the Iₘₐₓ axis (FIG. 7) to a location 534′. This may provide a moderate (e.g., 1-2%) reduction in peak component stress in the location 536 due to improved axial balance. Specifically, the decoupling of the trailing edge load faces improves the centering of the load transfer underneath (inboard of) the blade center of gravity 524. A better axially balanced blade transmits less bending stress to the outboardmost fir tree fillet at the neck 126. When implemented as a reengineering with no additional changes or as a retrofit of an existing blade, the reduction of load face associated with the chamfer may slightly increase bearing stress and P/A stress in the remaining areas. However, a typical blade will have sufficient margin to handle this.

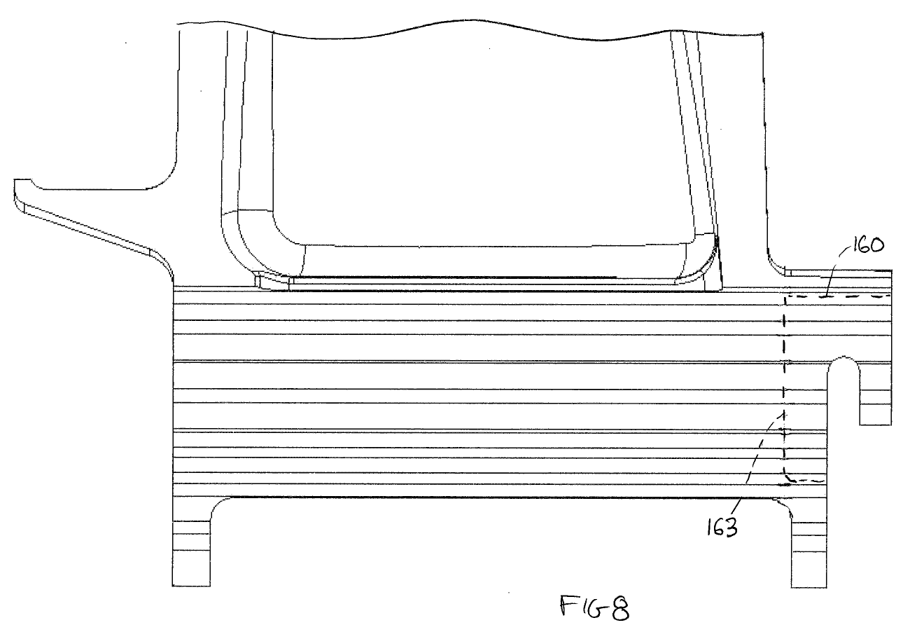

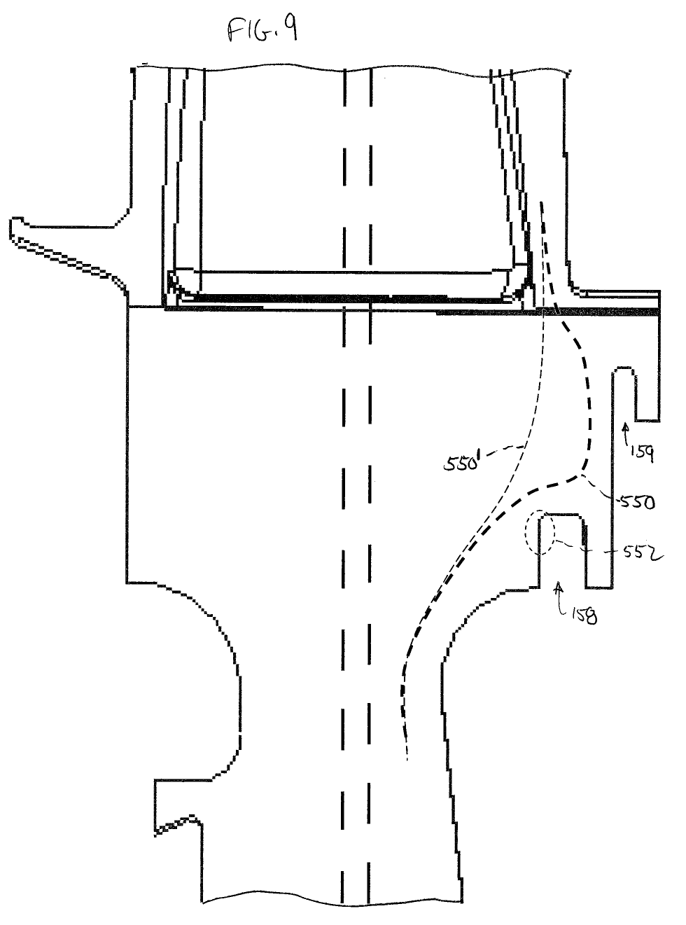

FIGS. 10 and 11 show the stress region 540 along the blade-to-slot contact region 138 of FIG. 4. The chamfer has a length L₃ along the broach angle. Exemplary L₃ is approximately 10-20% of the length L₂ along the broach angle. Exemplary L₂ are 4.5-7.5 inch. Exemplary L₃ may be 0.25-1.5 inch. At the aft face, the chamfer produces a gap 170 having a height of L₄ normal to the broach angle. Exemplary L₄ is 0.001-0.015 inch.

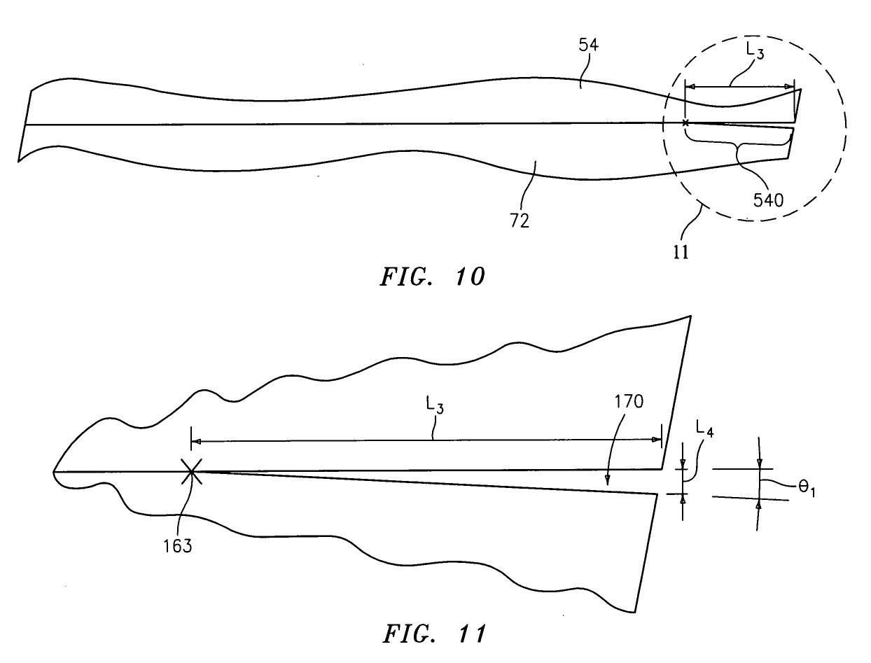

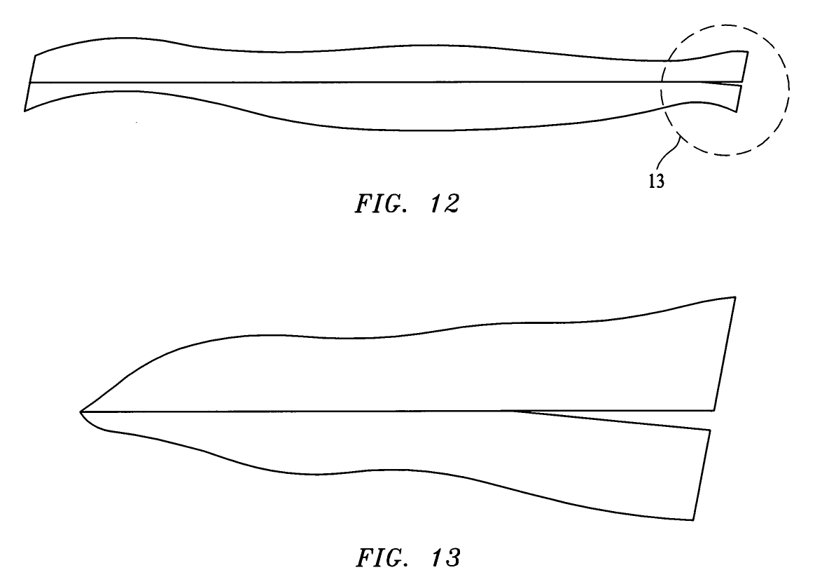

FIGS. 12 and 13 show the chamfered region 540 as correspondingly foreshortened along the contact region 130 due to the local forward offset of the aft face 94. FIGS. 14 and 15 show the region 542. The chamfered lengths are the same as in the region 540 but extents are much smaller. For example, with nominal lengths L₂ of six inches at the protuberances 116 and 122, and chamfer lengths L₃ of 0.85 inch, the region 540 has an exemplary gap height of 0.005 inch whereas the region 542 has a gap height of 0.002 inch.

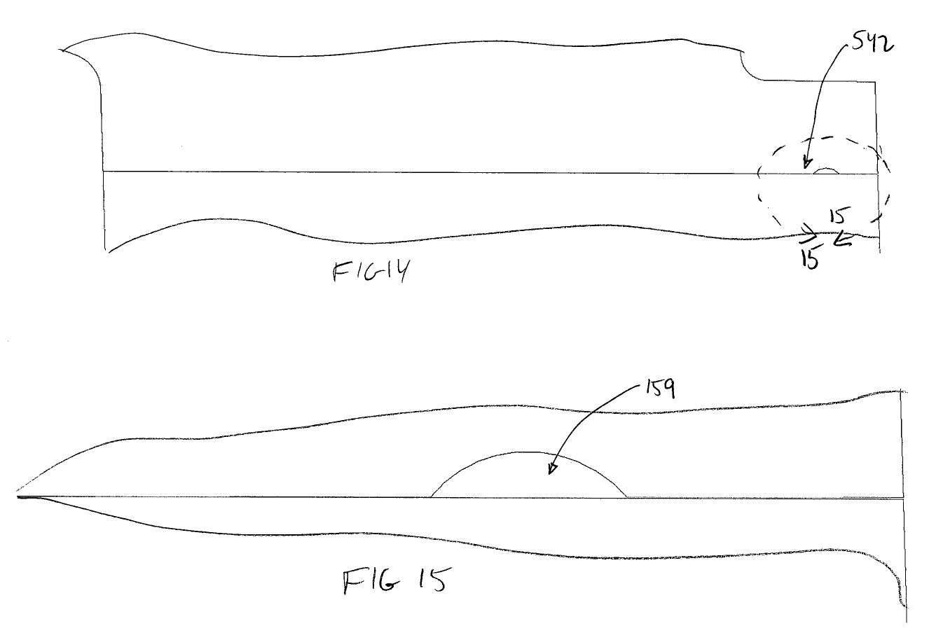

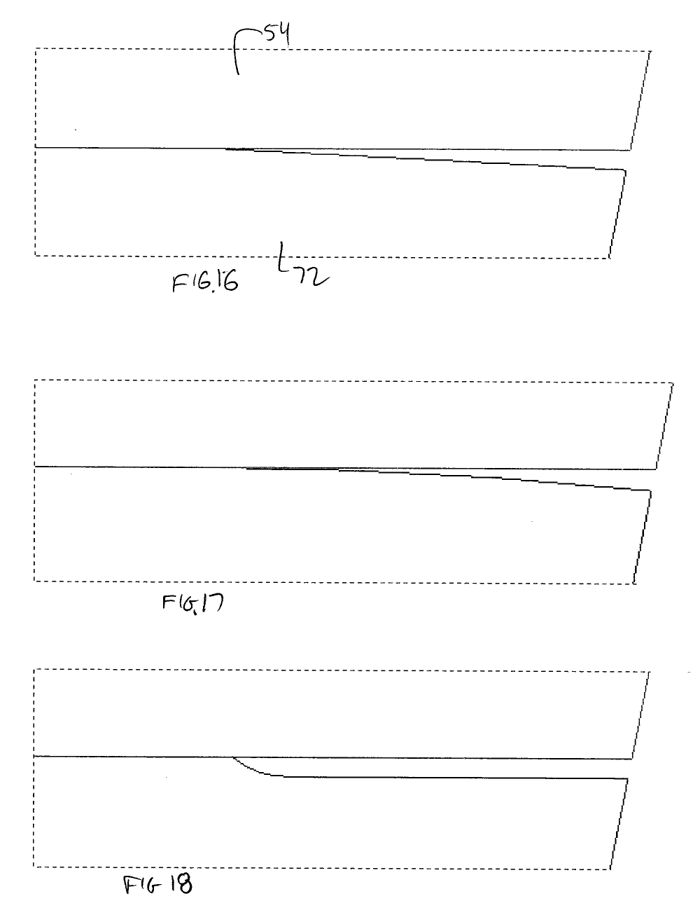

Among possible chamfer configurations, FIG. 16 shows an exemplary straight chamfer. FIG. 17 shows a convex arcuate chamfer. FIG. 18 shows a milled straight relief with concave radius, all producing the same net gap height at the aft face.

The relief may be implemented at various levels of abstraction. The relief may be implemented in a clean-sheet engineering of an engine. The relief may be implemented in the reengineering of an engine. In the most basic reengineering, only the relieved part is altered. The relief may be implemented in the modification of existing hardware. At one level, this modification may involve replacing a part on an engine with a relieved part. The relieved part may be of new manufacture or may be made by modifying an existing baseline part.

One or more embodiments have been described. Nevertheless, it will be understood that various modifications may be made. For example, when implemented in the remanufacturing or reengineering of a given engine or engine configuration, details of the existing engine or configuration may influence details of any particular implementation. Accordingly, other embodiments are within the scope of the following claims.

What is claimed is:

1. A turbine engine section comprising:
a disk having:
fore and aft faces;
a periphery; and
a circumferential array of slots, each slot:
extending between the first and second faces; and
open to the periphery;
a plurality of blades, each having:
an airfoil; and
an attachment root, the attachment root captured in an associated one of the slots and having a cross-sectional profile interfitting with a cross-sectional profile of the associated slot to lock the blade to the disk against radial extraction,
wherein:
along at least a first circumferential side of the root and slot there is a static engagement; and
along at least a portion of said first circumferential side, there is a slot-wise tapering gap having a length of at least 10% of a local length along the slot and a height of at least 0.001 inch.

2. The engine section of claim 1 wherein
the gap length is at least 0.25 inch.

3. The engine section of claim 2 wherein
the gap height is at least 0.002 inch.

4. The engine section of claim 1 wherein
the gap height is 0.004-0.006 inch.

5. The engine section of claim 1 wherein
the gap is formed by a chamfer along a portion of the root, an adjacent portion of the slot being unchamfered.

6. The engine section of claim 1 wherein:
the gap is an essentially constant chamfer along at least two protuberances/lobes of the attachment root and a fillet area therebetween.

7. The engine section of claim 1 wherein:
the gap is formed by a chamfer extending continuously along an outboard face of a head of the root, outboard through at least one lobe and to an outboard lobe.

8. A gas turbine engine blade comprising:
an airfoil having:
a leading edge;
a trailing edge;
a pressure side;
a suction side;
an inboard end; and
a tip;
a platform at the inboard end;
an attachment root depending from the platform and having:
leading and trailing end faces; and
first and second circumferential sides, generally respectively to the suction side and pressure of the airfoil,
wherein:
along at least a portion of at least one of said first and circumferential sides, the is a chamfer having a span of at least 0.25 inch and an end depth of at least 0.002 inch.

9. The blade of claim 8 wherein:
the chamfer extends to the trailing end face and is along the second circumferential side.

10. The blade of claim 8 wherein:
there is no corresponding chamfer directly on the opposite side of the root.

11. The blade of claim 8 wherein:
there is a corresponding chamfer directly on the opposite side of the root but of lesser depth.

12. The blade of claim 8 wherein:
the span is at least 0.6 inch.

13. The blade of claim 8 wherein:
the depth is at least 0.004 inch.

14. The blade of claim 8 wherein:
the chamfer is along an outboard protuberance/lobe of the root and a next protuberance/lobe inboard thereof and along a fillet area therebetween.

15. A method for reengineering a configuration of a gas turbine engine from a baseline configuration to a reengineered configuration comprising:
providing said baseline configuration having:
a turbine rotor stack comprising:
a plurality of disks; and
a plurality of stages of blades, each stage carried by an associated disk of the plurality of disks; and
a plurality of stator vane stages, interspersed with the blade stages; and reengineering so as to:
provide a longitudinally-varying relief on at least one adjacent surface of the blade roots and disk slots of at least one of the disks.

16. The method of claim 15 wherein:
the relief is only on an aft pressure side portion of the root.

17. The method of claim 15 wherein:
in the baseline configuration, the blade center of gravity is ahead of an Iₘₐₓ axis; and
in the reengineered configuration, the Iₘₐₓ axis is forward of the baseline configuration Iₘₐₓ axis and closer to the blade center of gravity.

18. The method of claim 17 wherein:
the forward shift of the Iₘₐₓ axis from the baseline configuration to the reengineered configuration is by at least 30% of the baseline configuration spacing of the blade center of gravity ahead of the Iₘₐₓ axis.
